(19) United States
(12) Patent Application Publication
(10) Pub. No.: US 2013/0320924 A1
(43) Pub. Date: Dec. 5, 2013

(54) BATTERY-CHARGING DEVICE AND METHOD OF CHARGING BATTERIES

(71) Applicant: The Gillette Company, Boston, MA (US)

(72) Inventors: Brien MERRILL, NEW FAIRFIELD, CT (US); David Thomas BIEDERMANN, Easton, CT (US); Steven Jeffrey SPECHT, Brookfield, CT (US)

(21) Appl. No.: 13/905,873

(22) Filed: May 30, 2013

Related U.S. Application Data
(60) Provisional application No. 61/654,669, filed on Jun. 1, 2012.

(51) Int. Cl. H02J 7/00

(52) U.S. Cl. CPC H02J 7/0042
USPC 320/110; 320/107; 320/137

(57) ABSTRACT

A battery-charging device and a method of charging batteries. The device comprises a housing, at least one hopper configured to receive a plurality of batteries, and at least one indexing barrel adjacent to the hopper and having a charging slot configured to receive and support one battery. The indexing barrel is structured to move the battery supported by the charging slot to and from a charging station comprising a set of charging terminals configured to contact terminals of the battery for charging the battery. The device further comprises at least one dispensing chute and at least one rejection chute. The chutes are configured to receive batteries that have been charged or rejected by the device, wherein each of the chutes is structured to contain several batteries.

### FIELD OF THE INVENTION

The invention relates to a battery-charging device and method of charging a battery. More particularly the battery charging device and method relate to the charging of rechargeable batteries in a shared environment.

### BACKGROUND OF THE INVENTION

Battery-powered devices are prevalent in the marketplace. Examples of such devices include phones, children's toys, flashlights, and digital cameras. In many instances, these devices may be powered by rechargeable, or secondary, batteries.

Depleted rechargeable batteries that are used in battery-powered devices are generally removed from the device for which they are intended, connected to a charger for charging, and then reinserted into the device once charged. A consumer using the device will need to wait until the battery is charged in order to continue using the device. Also, charger devices are generally limited in the number of charging positions available for the charging of depleted batteries. For example, a charger may have only four slots for charging depleted batteries. The fixed number of charging positions may also add to the length of time consumers may need to wait until they are able to charge a depleted battery. In addition, the consumer charging the batteries typically must place the depleted battery between charging terminals of a charger device. The insertion/removal of the batteries between the terminals may be exceedingly difficult for consumers with limited strength and/or dexterity in their fingers and/or hands, such as children and the elderly. Moreover, many consumers store batteries of multiple types in multiple states of charge in a common location. For example, a consumer may store primary and secondary batteries of similar sizes that are both charged and not charged within a common kitchen drawer. The consumer may not be able to easily determine which battery they will need to retrieve from this location to continue to operate their portable device. The consumer may need to resort to trial-and-error to determine a battery that is charged. Alternatively, the consumer may have to complete electrical measurements on the battery, such as checking the battery voltage, to determine which battery may power the device. There exists a need to provide a battery-charging device that reduces the time a consumer must wait to use a charged rechargeable battery, eliminates the need for a consumer to insert a rechargeable battery between charging terminals of a charger, and enables a consumer to easily determine whether a rechargeable battery is charged and ready for use.

### SUMMARY OF THE INVENTION

A battery-charging device comprises a housing, at least one hopper configured to receive a plurality of batteries, and at least one indexing barrel adjacent to the at least one hopper and having at least one charging slot thereon. The charging slot is configured to receive and support at least one battery. The at least one indexing barrel is structured and configured to move the at least one battery supported by the charging slot to and from the at least one set of charging terminals disposed inside the housing. The charging terminals are configured to contact terminals of the at least one battery for charging the at least one battery. The device comprises at least one dispensing chute configured to receive batteries that have been charged, wherein the at least one dispensing chute is structured to contain several batteries therein. The device may have several dispensing chutes, each configured to receive batteries of a certain type or types (or dimensions). Thus, the device may have, for example, a first dispensing chute configured to receive batteries of a first type and a second dispensing chute configured to receive batteries of a second type, wherein the batteries of the first type differ from the batteries of the second type in at least one dimension.

The device may further comprise at least one rejection chute configured to receive batteries that have been rejected by the device, wherein the at least one rejection chute is structured to contain several batteries therein. The rejection chute may be configured to receive the batteries of a first type and the batteries of the second type.

Each of the at least one hopper, the at least one dispensing chute, and the at least one rejection chute can be configured to accommodate batteries of differential types and dimensions.

The indexing barrel may be of any design that would serve the intended purpose. For example, the indexing barrel may comprise a wheel-type structure configured to rotate in at least one direction, thereby moving the at least one battery inside the housing. The charging slot of the indexing barrel may be shaped and sized to receive at least a battery of a first type and a battery of a second type, wherein the batteries of the first type differ from the batteries of the second type in at least one dimension. The device can be configured to charge various cylindrical batteries having differential diameters, for example, the batteries selected from the group consisting of AA-type batteries, AAA-type batteries, C-type batteries, and D-type batteries. The charging slot of the indexing barrel may have any suitable shape, for example, a concave, or a semi-circular shape—or any other shape that would allow the charging slot to accept a suitable battery. The charging slot may have a depth of at least about 6.75 mm.

When the device is disposed on a horizontal working surface, each of the at least one dispensing chute and the at least one rejection chute may be oriented, at least partially, at an angle relative to the working surface, so that batteries located in at least one of said chutes can roll or slide therein under the influence of the gravitational forces.

At least one of the discharge chutes may have a gate structured to prevent batteries contained therein from accidentally exiting from the chute. The gate may be disposed at an exit from the chute. The hopper, too, may have an associated gate structured to prevent discharged batteries from being accidentally taken from the hopper.

The device may be structured to determine at least one characteristic or condition selected from the group consisting of how many batteries are present in the device; battery position within the device; whether the hopper is full; whether the hopper is blocked; battery type; battery temperature, whether the battery is faulty or damaged, whether the dispensing chute is full, whether the reject chute is full, a position of the indexing barrel, whether the charging slot is occupied, whether the charging has started, whether the charging has been completed, voltage applied during the charging, current applied during the charging, whether any gate is open, and any combination thereof.

The device may further comprise a microcontroller for controlling at least one of current and voltage across terminals of the battery being charged. The microcontroller may also be involved in determining one or more characteristics or conditions selected from the group described herein above. The device may comprise a power converter for converting AC power to DC power.

A method of charging batteries comprises the steps of inserting at least one battery into a battery-charging device comprising a hopper configured to receive the at least one battery, an indexing barrel having a charging slot configured to receive and support the at least one battery, a charging station having a pair of charging terminals for charging the at least one battery, and at least one discharge chute for dispensing the at least one battery; causing the indexing barrel to receive the battery in the charging slot; moving the indexing barrel thereby transporting the battery to the charging station to cause terminals of the battery to make electrical contact with the charging terminals; determining whether the battery is fit for charging; charging the battery if the battery is determined to be fit for charging; rejecting the battery if the battery is determined not to be fit for charging; and moving the indexing barrel thereby transporting the battery from the charging station to the discharge chute. The method may further comprise a step of determining at least one of the characteristics or conditions selected from the group described herein above.

The step of moving the indexing barrel thereby transporting the battery from the charging station to the discharge chute may comprise either transporting the charged battery to a dispensing chute structured to receive batteries that have been charged or transporting the battery to a rejection chute structured to receive batteries determined to be unfit for charging in the device.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawing.

FIG. 1 is a perspective view of an embodiment of the device of the invention.

FIG. 2 is a perspective view of the embodiment shown in FIG. 1 including batteries a hopper, dispensing chutes, and a rejection chute of the device.

FIG. 3 is a sectional view of an embodiment of the device of the invention showing an indexing barrel receiving, in its charging slot, a battery to be charged by the device.

FIG. 4 is a sectional view of an embodiment of the device of the invention showing an indexing barrel positioned to dispense a battery charged by the device into a dispensing chute.

FIG. 5 is a sectional view of the embodiment shown in FIGS. 3 and 4 with an indexing barrel removed to show the charging stations and other elements of the device otherwise obscured by the indexing barrel in FIGS. 3 and 4.

FIG. 6 is a sectional view of an indexing barrel showing dimensions of a charging slot thereof.

FIG. 7 is a sectional view of the embodiment shown in FIGS. 3, 4, and 5, showing a rejected battery entering a rejection chute.

FIG. 8 is a perspective view of another embodiment of the device of the invention.

FIG. 9 is a sectional view of the embodiment shown in FIG. 8 showing an indexing barrel for receiving, in its charging slot, a battery to be charged by the device.

FIG. 10 is a sectional view of the embodiment shown in FIG. 9 with the indexing barrel removed to show the charging station and other elements of the device otherwise obscured in FIG. 9.

FIG. 11 is another sectional view of the embodiment shown in FIG. 8 showing an indexing barrel for receiving, in its charging slot, a battery to be charged by the device.

FIG. 12 is a sectional view of the embodiment shown in FIG. 11 with the indexing barrel removed to show the charging station and other elements of the device otherwise obscured in FIG. 11.

### DETAILED DESCRIPTION OF THE INVENTION

Electrochemical cells can be primary cells or secondary cells. Primary electrochemical cells, also referred to as primary cells or batteries, are meant to be discharged only once, most typically to exhaustion, and then discarded. Primary batteries therefore are not intended to be charged. On the other hand, secondary electrochemical cells, often referred to as rechargeable cells or batteries, can be charged many times, for example, fifty times, a hundred times, and so forth, by applying a voltage potential across a set of terminals of the rechargeable battery. Many portable electronic devices employ rechargeable batteries. Rechargeable batteries may be selected from various electrochemical systems, such as Nickel-Cadmium (NiCad), Nickel-Metal-Hydride (NiMHi), Lithium-Ion (Li-Ion), and Lithium-Polymer systems, depending upon the device for which the battery is intended. Rechargeable batteries may be cylindrical, prismatic, or of any other style of manufacture.

Some rechargeable batteries are sometimes called “smart batteries” for they are designed to interact with a microcontroller of a battery-charging device. Due to such interaction, the battery-charging device can charge the battery quickly and efficiently, recognize when the battery is not functioning properly, and take into account many conditions of the battery, for example, battery's thermal conditions that can occur during charging when a battery is being overcharged, being charged too rapidly, or has experienced some sort of failure. Such batteries may also include an internal communications device for transmitting information about the battery's condition, operation, and the like parameters.

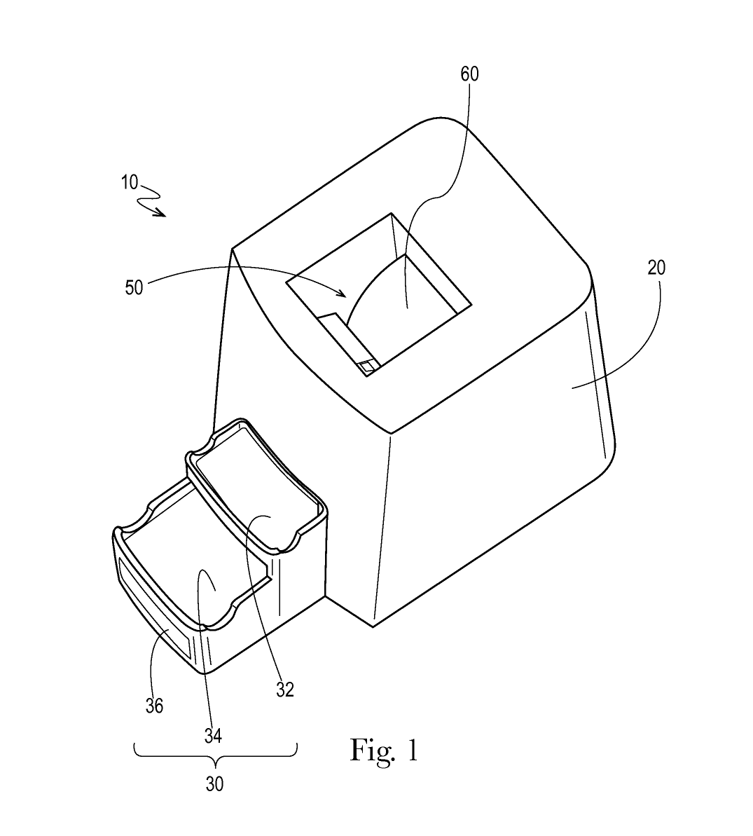

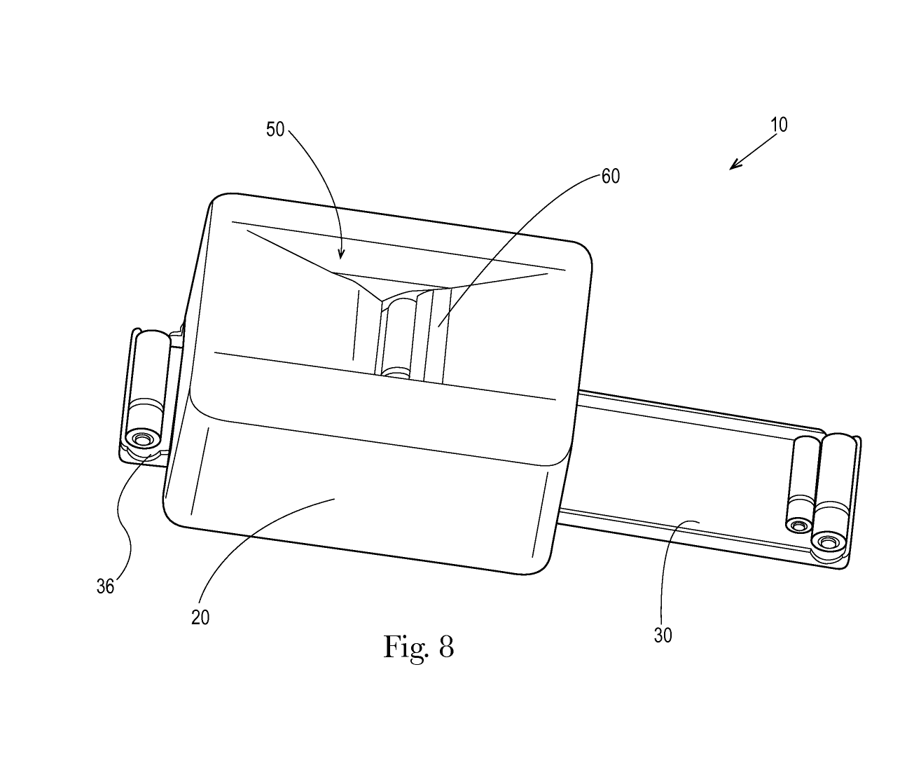

FIGS. 1 and 8 show embodiments of a battery-charging device 10 for charging rechargeable batteries in a shared environment, such as, for example, the environment in which one or more users have an opportunity to obtain recharged batteries from the device 10. The battery-charging device 10 includes a housing 20 containing therein an indexing barrel 60. The housing 20 may be configured to shroud and protect the internal components of the device 10, and may comprise any structure that can be configured to receive and store a plurality of depleted rechargeable batteries and include therein the necessary apparatus for charging those batteries. The device 10 may be powered using a conventional power supply.

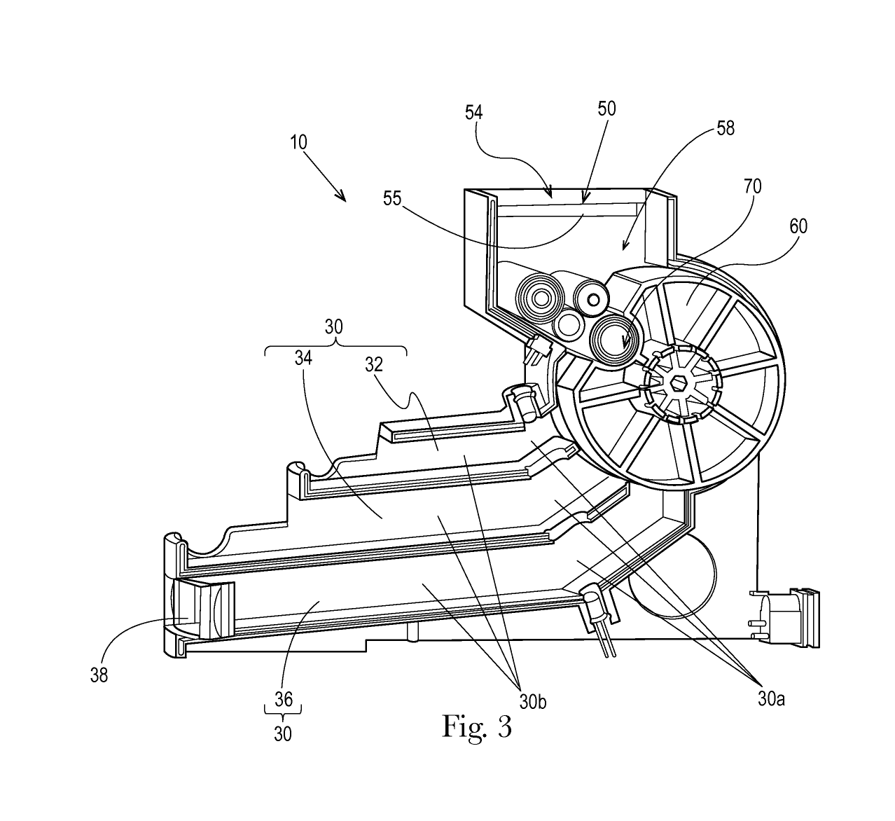

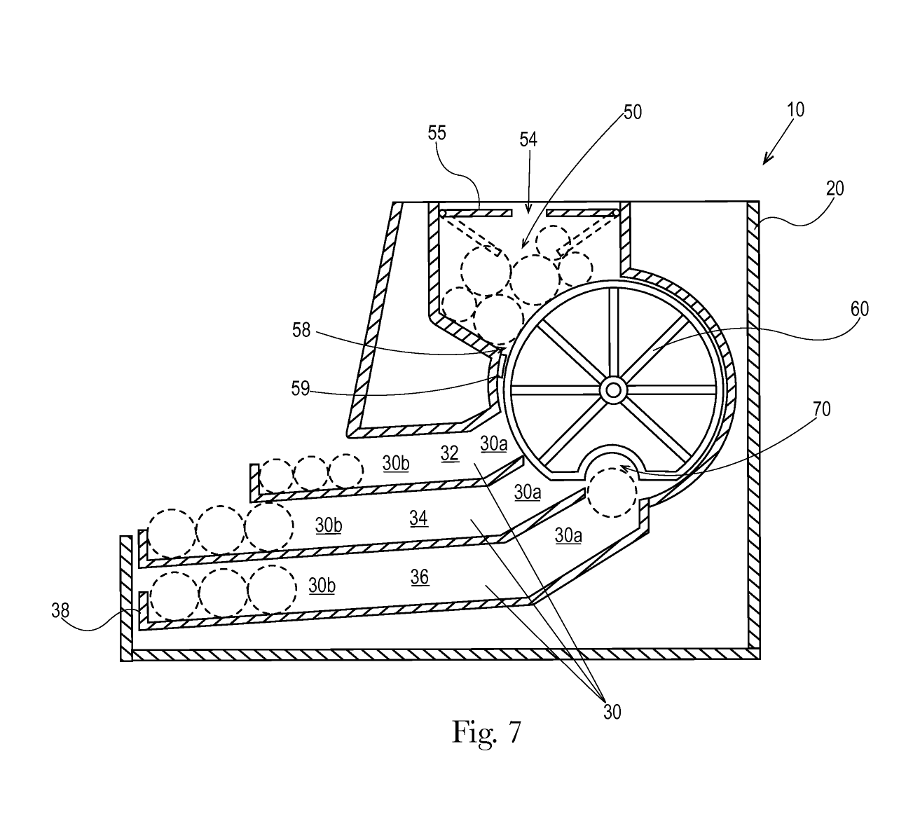

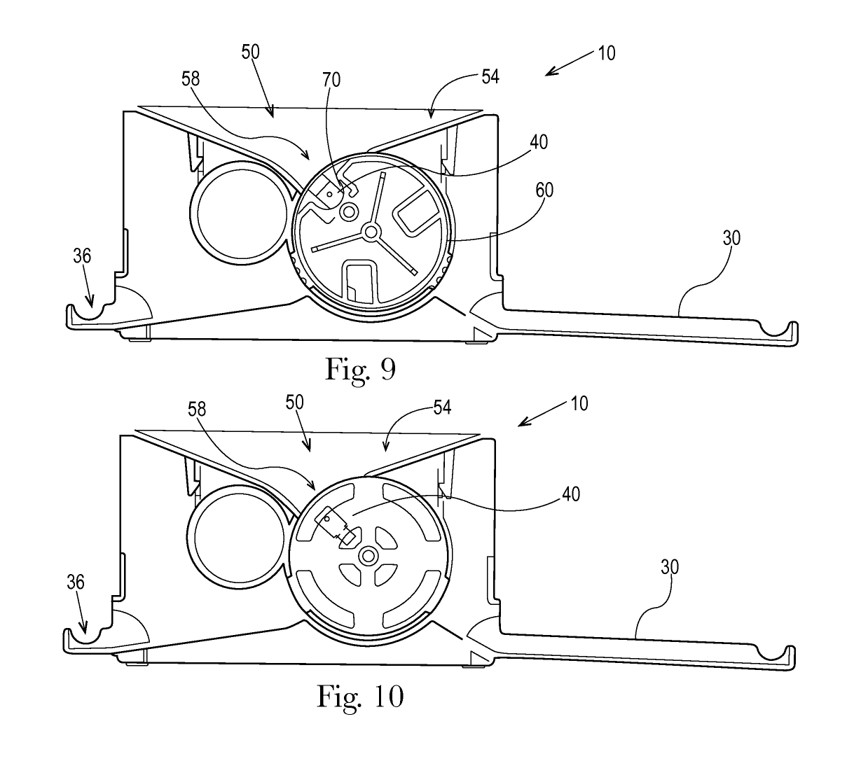

Referring to FIGS. 1-5 and 7-12, a hopper 50, disposed at a first end of the housing 20, is structured and configured to accommodate a variety of discharged batteries that a user can simply drop into the device and to allow the indexing barrel 60 to pick up at least a single battery for further processing inside the device 20. As in FIGS. 3, 4, 5, and 7, the hopper 50 may be configured to have a gate or closure 55 that would prevent or inhibit a user from inserting a battery into the device 10 when the hopper 50 is full. The gate 55 may be configured to prevent or inhibit users, especially those unfamiliar with the operation of the device 10, from attempting to take a discharged battery from the hopper 50. For this reason, for example, the gate may be structured to open only in one direction, allowing only the insertion of the batteries—but inhibiting withdrawal of the batteries from the hopper 50.

Referring to FIGS. 3-5, 7, and 9-12, the hopper 50 has a first opening 54 at a first end thereof, where the battery can be inserted into the device 10. The first opening 54 may be sufficiently sized to allow the passage of batteries therethrough. Moreover, the first opening 54 may be configured to allow the batteries to enter the hopper 50 in a particular way, for example, at a certain range of angles relative to the axis of the indexing barrel 60, thereby facilitating a desired position of the battery inside the hopper 50. The hopper 50 has a second opening 58 at a second end thereof, where the batteries are supported by an indexing barrel 60. The second opening 58 should be sufficiently large to enable batteries stored within the hopper 50 to properly engage a working surface of the indexing barrel 60. In the embodiment of FIGS. 3-5, 7, and 9-12, the second opening 58 is substantially opposite to the first opening 54.

The indexing barrel 60 is structured to have at least one charging slot 70, configured to receive one of the batteries disposed in the vicinity of the second opening 58 of the hopper 50. When the battery exits the hopper 50 through its second opening 58, it is received by the charging slot 70 on the indexing barrel 60. The second opening 58 should be configured and sized to preclude, or at least reduce, the likelihood of jamming when a battery exits the hopper 50 and enters the charging slot 70 of the indexing barrel 60.

The indexing barrel 60 may be of any design that is capable of moving, for example, rotating, within the housing 20. In the embodiment of FIGS. 3, 4, 7, 9, and 11, for example, the indexing barrel 60 comprises a wheel-like structure. The indexing barrel 60 may be operated manually or automatically. For example, the indexing barrel may be operatively connected to and controlled by a motor, servo, gear and pulley system, solenoid, or any other known means to enable the barrel 60 to move, for automated operation. The motor, servo, gear and pulley system, solenoid, or any other known means to enable the barrel 60 to move may be electrically connected to and controlled by a microcontroller.

The housing 20, the hopper 50, and the indexing barrel 60 may be manufactured from a variety of suitable materials routinely used for this and similar purposes. The housing 20 should have the strength and rigidity to permit the insertion, storage, and retrieval of a number of batteries. The indexing barrel 60 should withstand the forces exerted upon it during the placing, or dropping in, of batteries into the hopper 50 by the user. The hopper 50 should have sufficient integrity and rigidity to contain a plurality of batteries therein. Most plastics are suitable due to their light weight, low cost, and sufficient strength. In addition, plastics can be easily molded or extruded to have a variety of shapes and sizes to enable flexibility in aesthetics and design. Plastics may also be beneficially used for the hopper 50 and the indexing barrel 60, which should be made of material that is not electrically conductive. Exemplary plastics include acrylonitrile butadiene styrenepolypropylene (ABS), polyoxymethylene (POM), polypropylene (PP), polyethylene (PE), nylon, and polycarbonate (PC).

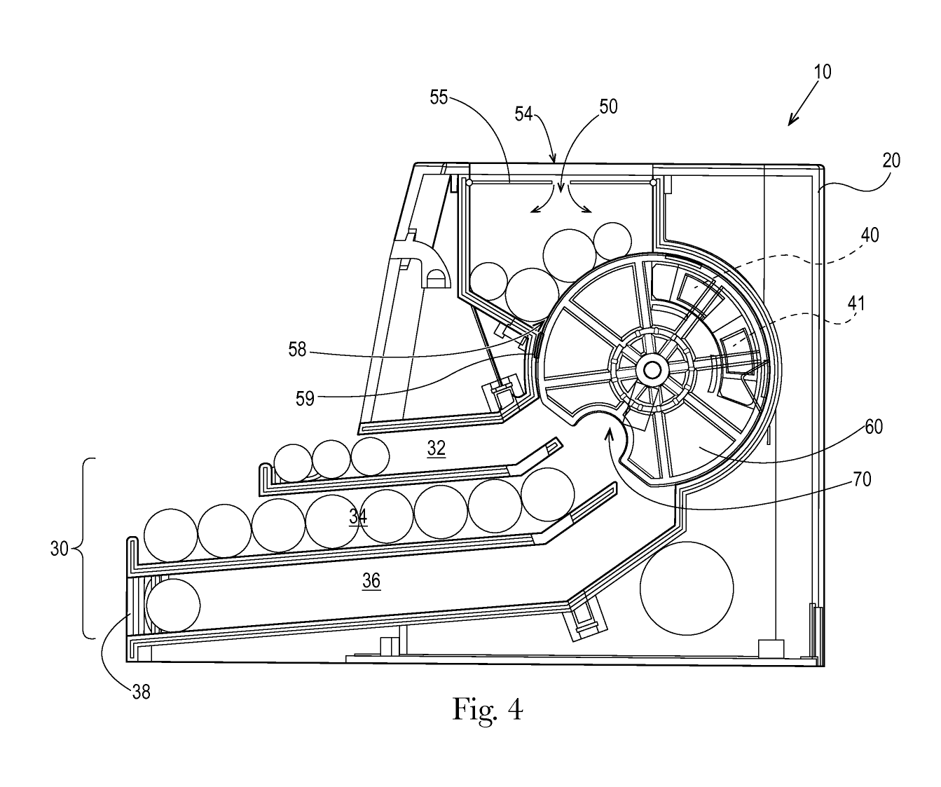

Referring to FIGS. 4, 5, 9, 10, 11, and 12, the device 10 includes at least one charging station 40 comprising a set of charging terminals. The charging station 40 may be disposed, for example, along a wall of the housing 20 so that the charging terminals of the charging station 40 can contact, or engage, charging terminals of the battery. The charging terminals of the charging station 40 may be made of any material capable of passing electric current, such as, for example, nickel-plated steel, copper, aluminum, tin, brass, and any mixture thereof, to the terminals of a battery. The charging terminals may be disposed within the wall so as to accommodate varying battery sizes.

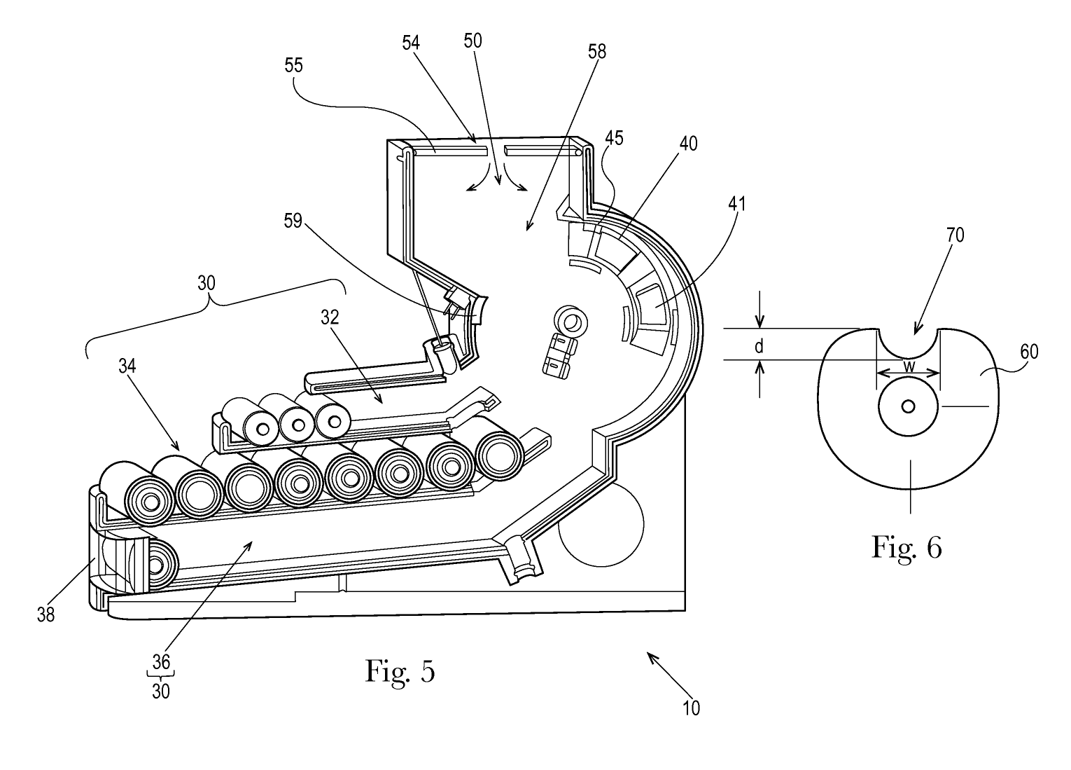

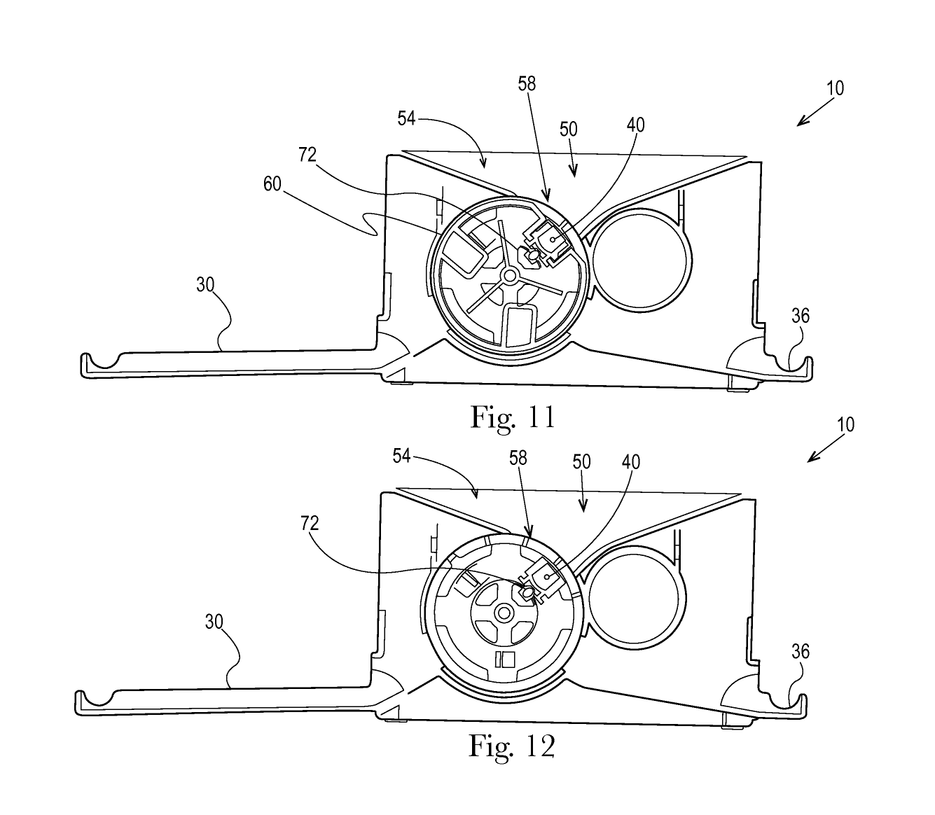

As an example, the charging terminals may be affixed to the wall via springs so that the distance between the charging terminals varies depending on the size of the battery being charged. Thus, the distance between the charging terminals of the charging station will increase when a larger battery, such as, for example, a AA battery, is placed between the charging terminals, relative to the distance between the charging terminals when a smaller battery, such as, for example, a AAA battery, is present between the charging terminals. As in FIGS. 11 and 12, a spring 72 may be affixed to the wall of the housing or wheel (not shown) to pull the charging terminals of the charging station 40 toward the terminals of the battery. Referring to FIGS. 4 and 5, the device 10 may have a first charging station 40 with a first set of charging terminals to accommodate a battery of a first size, for example, a AA battery; and a second charging station 41 with a second set of charging terminals to accommodate a battery of a second size, for example, a AAA battery.

The charging slot 70 of the indexing barrel 60 is configured to receive and hold a battery therein as the indexing barrel 60 moves from a first position, where the barrel 60 receives the battery from the hopper 50, to a second position, where the terminals of the battery are brought into contact with the charging terminals of the charging station 40. The charging slot 70 may be of any shape capable of holding the battery to be charged—and may be configured to hold a battery having a prismatic, cylindrical, or any other shape. The charging slot 70 may have squared edges, rounded edges, or any combination thereof so long as the charging slot 70 is sized appropriately to enable easy unobstructed insertion of a single battery therein.

In an exemplary embodiment of FIG. 6 the charging slot 70 is shown as having a slot depth “z” and a slot width “w.” The depth and width of the slot 70 must be such that any battery within the hopper 50 may easily fit within the confines of the charging slot 70. In addition, the slot's depth and width must be sized to prevent more than one battery from being captured in the charging slot 70. The slot's depth, in order to capture one battery within the charging slot 70 and help prevent jamming, should be dimensioned as a function of the relevant sizes of the batteries being fed into the device 10.

For example, for the purposes of charging cylindrical batteries, the minimum slot depth (zₘᵢₙ) should be more than about ½ the diameter of the largest battery size (dₘₐₓ) being inserted into the device: zₘᵢₙ>0.5(dₘₐₓ); and the maximum slot depth (zₘₐₓ) should be less than about ½ times the diameter of the smallest battery size (dₘᵢₙ) being inserted into the device 10: zₘₐₓ<1.5(dₘᵢₙ). In addition, the minimum slot width (wₘᵢₙ), for example, should be greater than about the diameter of the largest battery size (dₘₐₓ) being inserted into the device: wₘᵢₙ>dₘₐₓ.

Cylindrical batteries come in varying sizes of diameter and length. The International Electrotechnical Commission (IEC), for example, has established standard diameters and lengths for batteries, including cylindrical batteries readily available to consumers at retail such as AAA batteries, AA batteries, C batteries, and D batteries. The minimum and maximum depths of the charging slot will depend upon the size combinations of the batteries to be inserted into the battery charging device, as exemplified in Table 1 below.

TABLE 1
Combinations of batteries and required
depth and width of the charging slot.

| Battery Size | Slot | Minimum Slot | Maximum Slot |
|---|---|---|---|
| Combinations | Width (mm) | Depth (mm) | Depth (mm) |
| AAA, AA | 14.6 | 6.75 | 14.25 |
| AA, C | 26.3 | 12.45 | 20.25 |
| AAA, AA, C | 26.3 | 12.45 | 14.25 |
| C, D | 34.3 | 16.15 | 37.35 |
| AA, C, D | 34.3 | 16.15 | 20.25 |

The device 10 further has at least one discharge chute 30 intended to receive, contain, and dispense the charged batteries and/or batteries that have been determined not fit for charging and therefore rejected by the device 10. Thus, the at least one discharge chute 30 is, in essence, a conduit and storage for the batteries after they have been processed (i.e., charged or rejected) inside the device 10. In the embodiment of FIGS. 8-12, the device 10 includes a single rejection chute 36 and a single discharge chute 30. In the embodiment of FIGS. 1-5, the at least one discharge chute 30 may comprise, for example, a first dispensing chute 32, a second dispensing chute 34, and a rejection chute 36. The first dispensing chute 32, the second dispensing chute 34, and the rejection chute 36 may run through a central axis of the housing 20, although other configurations of the device 10, in which these elements are not aligned along the axis, or in which the device 10 is not symmetrical and otherwise may not have a easily recognizable central axis, are also contemplated. But regardless of a specific embodiment, the discharge chutes 30, and therefore the device 10 as a whole, including the housing 20, can be made to accommodate the storage of the desired number of batteries.

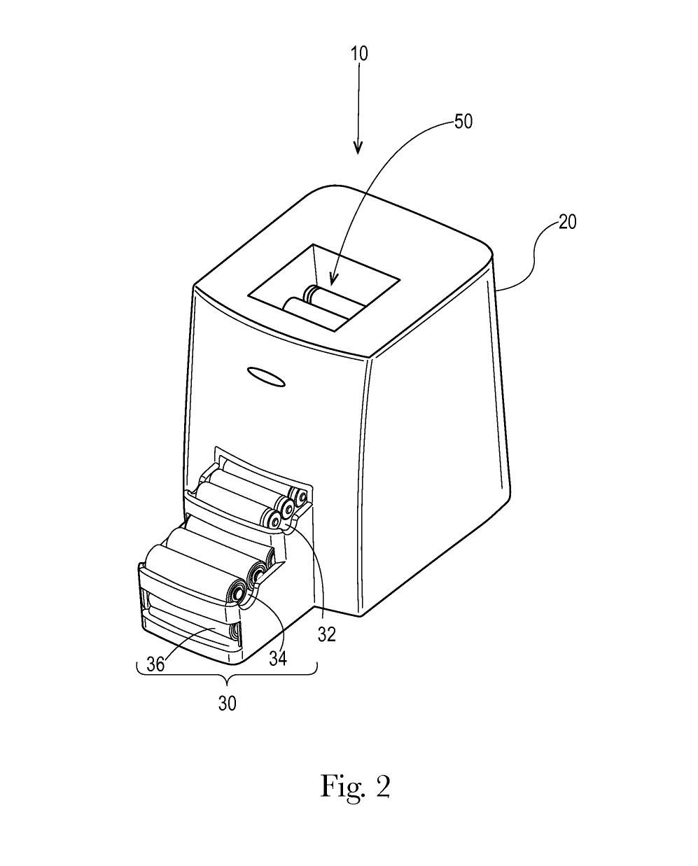

In the embodiment of FIGS. 3-7, the device 10 is configured such that when the device is disposed on a horizontal working surface, the hopper 50 is above the discharge chutes 30, while the first dispensing chute 32 is above the second dispensing chute 34, and the second dispensing chute 34 is above the rejection chute 36. This structure allows one to rely on the gravitational forces that assist the batteries to move inside the device 10. Each of the chutes 30, for example, may comprise at least two parts: a first, relatively shorter part 30a which is encountered by the battery once the battery separates from the indexing barrel 60, and a second, relatively longer part 30b, which is configured to accumulate several batteries. The first part 30a may be beneficially configured to have an incline sufficient to facilitate the movement of the batteries just separated from the indexing barrel 60 towards the second part 30b of the chute 30. The second part 30b may also be configured to be inclined, although at a lesser degree relative to that of the first part 30a, as shown in FIGS. 2 and 3. This or similar configurations of the discharge chutes 30, which may be particularly beneficial for the cylindrical batteries that can roll inside the chutes 30, are intended to facilitate progressive movement of the batteries towards exits from the chutes 30. Other embodiments, having various configurations and relative positions of the discharge chutes 30, are contemplated.

The first dispensing chute 32 is configured to accumulate batteries of a first type, and a second dispensing chute 34 is configured to accumulate batteries of a second type. The rejection chute 36 is configured to accumulate batteries that were rejected by the device 10 for at least one reason. Those may include batteries of both first and second types. The rejection reasons may include, for example, the lack of acceptable (rechargeable) chemistry, or a failure of the battery to meet at least one of the quality checks conducted by the device 10 before the charging begins.

A movable gate, or closure, may be affixed to, or otherwise associated with, any of the discharge chutes 30, to prevent a charged or rejected battery from inadvertently exiting the device 10. The gate may also help to reduce user's confusion as to whether a battery is charged or rejected. FIGS. 3-7, for example, show an embodiment in which there is a gate 38 at the exit from the rejection chute 36. The gate may be movably affixed to the chute—or arranged otherwise to serve the described function, using any known means, as one skilled in the art would appreciate.

Any gate in the device 10, including the gate 38 of at least one of the chutes 30 and the gate 55 of the hopper 50, may comprise, for example, a mechanical and/or electrical means for controlling the movement (for example dispensing) of batteries to and from the device 10. Illustratively, the gate may be thought of as a mechanical or electrical barrier that inhibits the passage of a battery through an opening in the chute 30 or the hopper 50. The gate may be a physical barrier that is opened and closed via a solenoid, a simple motor, or other equivalent means. The gate may also be any device configured to open or close in one direction or two directions. The gate may be configured to open in only one direction, to permit the insertion of a battery into the device 10, but inhibit the removal of the battery from the device 10 via the same gate through which the battery was inserted. The gate may be spring-actuated or actuated by other mechanical means. The gate may be manually actuated by a user, for example, by pushing a button thereby releasing a spring mechanism controlling the gate. The gate may be activated by electronic means such as solenoids that are capable of being controlled by a microcontroller. The term “gate” therefore is not meant to imply any particular structure, but rather implies the function of inhibiting the passage of a physical object (battery) through an opening.

The device 10 may be structured to determine various characteristics of the battery present in between the battery charging terminals 40 by passing voltage and/or current to the battery through the battery charging terminals 40. Thus, the device 10 may be structured to determine the polarity of the battery, for example, by enabling the device 10 to measure the open circuit voltage of the battery and determine whether the measured voltage is positive or negative. The device 10 may be structured to determine whether the battery is rechargeable or primary, for example, by enabling the device 10 to briefly apply a current to the cell and monitor the voltage response to see if the responding voltage is different from a set value within the device. The device 10 may be structured to determine whether the battery is faulty, such as when the battery has a short, a high overvoltage value, or a high resistance. The device 10 may also be structured to determine whether the battery is functioning properly during the charging, for example, by enabling the device 10 to monitor the battery's voltage and/or the battery's temperature. The device 10 may be structured to determine whether the battery has reached the end of its usable life, for example, by enabling the device 10 to measure the battery's resistance and compare the measured resistance to a preset resistance value or performing columbic counting on the battery.

The device 10 allows several users within a household, workplace, or other shared environment to easily and readily obtain one or more charged batteries. The user may insert at least one battery into the hopper 50 of the device 10. Typically, the hopper will contain several batteries that wait to be charged. With reference to FIG. 3, for example, the indexing barrel 60 moves to the first position within the device 10. One of the batteries inside the hopper 50 enters the charging slot 70 of the barrel 60. The indexing barrel 60 then moves (rotates clockwise in FIG. 3) to a second, or charging position so that the terminals of the battery inside the charging slot 70 make electrical connection with the terminals of the charging station 40. The device 10 may then determine at least one characteristic or condition of the battery and to verify whether the battery is fit for charging. The device may determine, for example the polarity of the battery, whether the battery is rechargeable or primary, whether the battery is faulty or damaged, whether the battery is functioning properly during the charging, whether the battery has reached the end of its usable life, and any combinations thereof. These characteristics are merely exemplary; the device 10 may be designed to be capable of determining other characteristics of the battery, if desired.

If the device 10 determines that the battery in the charging station 40 is rechargeable and otherwise fit for charging, the charging begins. The device 10 applies, through the terminals of the charging station 40, a charging current across the terminals of the battery. The charging continues until the device 10 determines that the battery is charged. Once the device 10 determines that the battery is charged, the barrel 60 moves (rotates counterclockwise in FIG. 3), thereby disengaging the battery terminals from the charging terminals 40. The barrel 60 transports the charged battery to a third, or dispensing position, where the battery can enter one of the dispensing chutes 32, 34.

The device 10 can be structured and configured such that each of the first and second dispensing chutes 32, 34 can accept batteries of only a certain type or size. In FIGS. 3-5, for example, the first chute 32, sized to accept AAA batteries, will not accept the relatively larger AA batteries. The first chute 32 is located above the second chute 34. Therefore, when a charged AA battery, carried by the barrel 60 (moving counterclockwise), reaches the third position adjacent to the entrances of the dispensing chutes 32, 34, the charged AA battery will not be able to enter the first dispensing chute 32, and the barrel 60 will continue to move until the charged AA battery reaches the second chute 34, designed for the AA battery size. Then, the gravitational forces will cause the charged AA battery to disengage from the slot 70 and enter the second chute 34.

When, on the other hand, the indexing barrel 60 carries a charged AAA battery, in a manner similar to that described above with respect to the AA battery, the charged AAA battery will fit the first dispensing chute 32, and thus will separate from the barrel 60 once the charged AAA battery reaches an entrance of the first chute 32.

If the device 10 determines that the battery is not fit for charging for any reason, the device 10 rejects the battery and the indexing barrel 60 transports the rejected battery to the rejection chute 36. If the battery is rejected, the barrel 60 moves (rotates clockwise in FIG. 3) to a fourth position, where the rejected battery can enter the rejection chute 36. The rejection chute can be configured to accept batteries of various types and sizes. Once the rejected battery is dispensed into the rejection chute 36, the indexing barrel 60 returns to the first position to receive a new battery and to transport it to the second, charging position, as is described herein above. This process can be repeated for as long as there is at least one battery in the hopper 50, the dispensing chutes 32, 34 and/or the rejection chute 36 are not full, or until the device 10 is turned off.

The device 10 may include a microcontroller 45 (FIG. 5) for applying a DC current and voltage across the terminals of the rechargeable battery and various sensors. The microcontroller 45 may be used, for example, to determine, based on feedback from the various sensors within the device 10 and/or the battery, the most appropriate voltage and current to apply to the charging terminals. The microcontroller 45 may be any electronic circuit for controlling the flow of electricity to a battery being charged. The “microcontroller” may also be referred to as a “battery charger” or simply a “charger”—and may refer to any device configured to apply a charge to a rechargeable battery.

A variety of battery-charging circuits known in the art usually include a shunt regulator to control the amount of charge that is delivered to the battery. The microcontroller 45 can perform various functions within the device 10. For example, the microcontroller 45 can recognize when the battery has reached its maximum charge and reduce or cease the current/voltage delivered to the charging terminals. The microcontroller generally has the ability to charge numerous batteries simultaneously, but in embodiments where large numbers of batteries are to be stored in the housing, multiple controllers may be used. The microcontroller 45 may be configured to determine the polarity of the battery present and to analyze the charge status of a battery to determine whether the battery is functioning correctly, has reached is usable service life, and other battery characteristics as is described herein.

Each gate may be controlled via a solenoid (not shown) that may be connected to the microcontroller 45, as any skilled in the art will readily recognize. Those skilled in the art will also recognize that there are many alternatives to a solenoid for controlling the movement of the gate and that a solenoid is merely illustrative, and not exhaustive, of the available means. For example, a simple motor may be used to control battery dispensing (or open and close a gate). In addition, a piezoelectric system that inhibits removal may also be used to control battery dispensing. Other such mechanical and electrical systems are, of course, useful for this function.

The device may include a power converter (not shown) for converting AC power to DC power. The power converter may be any device used to rectify and regulate electricity for the purpose of supplying power to any electric device, such as supplying power to batteries for purposes of charging them. The power converter may be also referred to as a power supply, power brick, power source, and the like. The power supply may be a regulated DC current supplied to the terminals at a specified voltage. The power supply may draw its power from an AC outlet and, thus, may also include a rectifier to convert AC power to DC power. AC/DC power converters for use with rechargeable batteries may also incorporate a plurality of rectifiers, capacitors, and other circuitry well know to those skilled in the art, to ensure that the DC power has a low ripple and relatively constant voltage.

The device 10 may include various sensors to indicate various characteristics of the device 10 and/or the battery during the charging process, such as, for example, battery position within the device, battery type, battery fault, battery present, hopper full, hopper blocked, dispensing chute full, rejection chute full, indexing home, and any combination thereof. The hopper 50, for example, may include a position sensor 59 that indicates to the device 10, through electrical connection to the microcontroller, for example, or otherwise, the position of the indexing barrel 60. As an example, referring to FIGS. 3-7, the position sensor 59 may be located at one end of the hopper indicating a position where a battery may enter the charging slot 70.

Charging algorithms may be employed to maximize the battery charge rate. The sensors may provide necessary input into the algorithm to monitor the status of the battery being charged in the charging station 40 and to modify the current and/or voltage applied to the charging terminals. For example, the device 10 may have thermal sensors to monitor battery temperature, which can be indicative of the battery's charging state, such as, for example, an indication that a battery is being charged too rapidly, or an indication that a cell within a battery has failed. Sensors within the battery itself may also have contacts on the outside of the battery to engage terminals disposed within the chute for receiving and transmitting battery's status information to a microcontroller that regulates the voltage and/or current applied to the terminals.

The dimensions and values disclosed herein are not to be understood as being strictly limited to the exact numerical values recited. Instead, each such dimension is intended to mean both the recited value and a functionally equivalent range surrounding that value, unless otherwise specified. For example, a dimension disclosed as “20.25 mm” is intended to mean “about 20.25 mm”.

Nor is the present invention to be understood as being limited to the particular embodiments illustrated and described herein. While, for example, the several figures herein show an embodiment of the device 10 comprising a single indexing barrel 60 having a single charging slot 70, other embodiment are possible and fully contemplated. The present invention contemplates, for example, an embodiment of the device 10 comprising two, three, or more indexing barrels 60, which can work together either in unison or independently from one another, charging thereby two, three, or more batteries simultaneously. Furthermore, the present invention contemplates an embodiment of the device 10 having more than one charging stations 40, each having more than one set of charging terminals, so that several batteries can be charged at the same time. In addition, the present invention contemplates an embodiment of the device 10, in which the indexing barrel 60 has two or more charging slots 70.

It would be obvious to those skilled in the art that various other changes and modifications can be made without departing from the spirit and scope of the invention. It is therefore intended to cover in the appended claims all such changes and modifications that are within the scope of this invention.

What is claimed is:

1. A battery-charging device, comprising:
a housing;
at least one hopper configured to receive a plurality of batteries;
at least one indexing barrel adjacent to the at least one hopper and having at least one charging slot configured to receive and support at least one battery, the at least one indexing barrel being structured and configured to move the at least one battery supported by the charging slot to and from at least one set of charging terminals disposed inside the housing and configured to contact terminals of the at least one battery for charging the at least one battery; and
at least one dispensing chute configured to receive batteries that have been charged, wherein the at least one dispensing chute is structured to contain several batteries therein.

2. The device of claim 1, having one set of charging terminals and one dispensing chute configured to receive batteries that have been charged.

3. The device of claim 1, wherein the device further comprises at least one rejection chute configured to receive batteries that have been rejected by the device, wherein the at least one rejection chute is structured to contain several batteries therein.

4. The device of claim 3, wherein each of the at least one hopper, the at least one dispensing chute, and the at least one rejection chute is configured to receive batteries of differential types and dimensions.

5. The device of claim 3, wherein the at least one dispensing chute comprises at least a first dispensing chute and a second dispensing chute, the first dispensing chute being configured to receive batteries of a first type; and the second dispensing chute being configured to receive batteries of a second type, wherein the batteries of the first type differ from the batteries of the second type in at least one dimension.

6. The device of claim 5, wherein the rejection chute is configured to receive the batteries of a first type and the batteries of the second type.

7. The device of claim 1, wherein the indexing barrel comprises a wheel-type structure configured to rotate in at least one direction, thereby moving the at least one battery inside the housing.

8. The device of claim 1, wherein the at least one charging slot is configured to receive a battery of at least a first type and a battery of at least a second type, wherein the battery of the first type differs from the battery of the second type in at least one dimension.

9. The device of claim 8, wherein the device is configured to charge cylindrical batteries, and wherein the at least one dimension is a diameter thereof.

10. The device of claim 9, wherein the charging slot comprises a semi-circular shape and has a depth of at least about 6.75 mm.

11. The device of claim 1, wherein the device is configured to charge batteries selected from the group consisting of AA batteries, AAA batteries, C batteries, and D batteries.

12. The device of claim 3, wherein when the device is disposed on a horizontal working surface, each of the at least one dispensing chute and the at least one rejection chute are oriented, at least partially, at an angle relative to the working surface, so that batteries located in at least one of said chutes can roll or slide therein under the influence of the gravitational forces.

13. The device of claim 3, wherein the device is configured such that when the device is disposed on a horizontal working surface, the at least one hopper is above the at least one dispensing chute and the at least one rejection chute, and the at least one dispensing chute is above the at least one rejection chute.

14. The device of claim 3, wherein at least one of the at least one dispensing chute and the at least one rejection chute has a gate structured to prevent batteries from accidentally exiting the at least one dispensing chute or the at least one rejection chute.

15. The device of claim 1, wherein the at least one hopper has a gate structured to prevent discharged batteries from being accidentally taken from the at least one hopper.

16. The device of claim 1, further comprising a microcontroller for controlling at least one of current and voltage across terminals of the at least one battery being recharged.

17. The device of claim 1, further comprising a power converter for converting AC power to DC power.

18. The device of claim 3, wherein the device is structured to determine at least one characteristic or condition selected from the group consisting of a number of batteries present in the device; battery position within the device; whether the hopper is full; whether the hopper is blocked; battery type; battery temperature, whether the battery is faulty or damaged, whether the dispensing chute is full, whether the rejection chute is full, a position of the indexing barrel, whether the charging slot is occupied, whether the charging has started, whether the charging has been completed, voltage applied during the charging, current applied during the charging, whether any of the chutes has its gate open, and any combination thereof.

19. A method of charging rechargeable batteries, the method comprising steps of:
(a) inserting at least one battery into a battery-charging device comprising a hopper configured to receive the at least one battery, an indexing barrel having a charging slot configured to receive and support the at least one battery, a charging station having a pair of charging terminals for charging the at least one battery; and at least one discharge chute for dispensing the at least one battery;
(b) causing the indexing barrel to receive the at least one battery in the charging slot;
(c) moving the indexing barrel thereby transporting the at least one battery to the charging station to cause terminals of the at least one battery to electrically engage the charging terminals;
(d) determining whether the at least one battery is fit for charging;
(e) charging the at least one battery if the at least one battery is determined to be fit for charging;
(f) rejecting the at least one battery if the battery is determined not to be fit for charging; and
(g) moving the indexing barrel thereby transporting the at least one battery from the charging station to the at least one discharge chute.

20. The method of claim 19, further comprising a step of determining at least one characteristic or condition selected from the group consisting of how many batteries are present in the device; battery position within the device; whether the device is full; whether the hopper is blocked; battery type; battery temperature, whether the battery is faulty or damaged, whether the at least one discharge chute is full, a position of the indexing barrel, whether the charging slot is occupied, whether the charging has started, whether the charging has been completed, voltage applied during the charging, current applied during the charging, whether the at least one discharge chute has its gate open, and any combination thereof.

21. The method of claim 19, wherein the step of moving the indexing barrel thereby transporting the at least one battery from the charging station to the at least one discharge chute comprises either transporting the at least one battery to a dispensing chute structured to receive batteries that have been charged or transporting the at least one battery to a rejection chute structured to receive batteries that have been found not fit for charging by the device.
